(19) United States
(12) Patent Application Publication
(10) Pub. No.: US 2010/0058671 A1
(43) Pub. Date: Mar. 11, 2010

(54) CERIUM OXIDE AND METHOD FOR PRODUCING THE SAME

(76) Inventor: Shuji Ogura, Saitama (JP)

Correspondence Address: ROBERTS & ROBERTS, LLP;ATTORNEYS AT LAW, P.O. BOX 484, PRINCETON, NJ, 08542-0484, US

(21) Appl. No.: 12/514,824

(22) PCT Filed: Sep. 4, 2008
(86) PCT No.: PCT/JP2008/065937

§ 371 Date: May 14, 2009

(30) Foreign Application Priority Data
Sep. 13, 2007 (JP) 2007-237484

(51) Int. Cl. C01F 17/00; B24D 3/00; C09K 3/14; C09C 1/68

(52) U.S. Cl. 51/309; 428/402

(57) ABSTRACT

The present invention relates to a cerium oxide and a production method thereof. Especially, it is an object of the present invention to provide a cerium oxide which realizes a high smoothness comparable to that of colloidal silica and has a large polishing rate. Further, the present invention provides a cerium oxide which has good cleaning properties of the polishing surface after polishing. The present invention relates to a cerium oxide having an average particle size of 0.5 μm or less and a crystallite diameter of 8 nm to 80 nm, characterized in that the cerium oxide settles out in 3 mass % aqueous brine to a predetermined sedimentation volume when the cerium oxide is formed as a slurry containing cerium oxide in a concentration of 2 mass %, and the sedimentation volume after leaving the cerium oxide slurry to stand for 24 hours after stirring is 2.5 to 15.0 mL/g.

### TECHNICAL FIELD

The present invention relates to cerium oxide and a method for producing the same, and more specifically to cerium oxide which is suitable as an abrasive.

### BACKGROUND ART

Cerium oxide is used for a wide variety of applications, such as for an abrasive, an ultraviolet absorber, a catalyst support, a glass decolorizing agent, ceramics and the like. Properties which match each of these applications are required. As an example of applications for an abrasive, cerium oxide is used in the glass for a liquid crystal display, and in surface finishing of hard disks, photo masks and the like.

In abrasive applications, the polished surface after polishing has to be smooth and the polishing rate needs to be large. Therefore, even cerium oxide, which is a raw material for an abrasive, the purity, physical properties and the like need to be controlled. Patent Document 1 discloses a cerium oxide having a small average particle size and a uniform particle size and shape, as a cerium oxide which has preferred properties as an abrasive. Further, there is a need for an ultraviolet absorber which has high ultraviolet ray blocking efficiency, but through which light in the visible region can be easily transmitted. In addition, there is a need for an improvement in the degree of dispersion of a precious metal and the like, which are catalyst particles, as a supported material for a catalyst.

Accordingly, as a method for producing such cerium oxides, Patent Document 1 describes a method in which cerium nitrate and a base are reacted by stirring and mixing, and then the resultant product is heated rapidly to 70 to 100° C. Further, as a method for producing a cerium oxide with a relatively small particle size, Patent Document 2 describes a production method in which cerium hydroxide is produced at a temperature of 40° C. or below and at a pH of 9 or more, and then oxidized at a temperature of 60° C. or below and at a pH of 5 or more by an oxidizing agent. In addition, Patent Document 3 describes a production method in which cerium hydroxide is produced in an inert gas at a pH of 7 to 11, and then oxidized by a heat treatment using an oxidizing agent.

If the cerium oxide with a relatively small particle size described in the above patent documents is used as an abrasive, polishing scratches are not easily formed on the polished surface after polishing, and the surface finishing of the glass and the like can be carried out well.

Patent Document 1: Japanese Patent Laid-Open No. 9-142840

Patent Document 2: Japanese Patent Laid-Open No. 2000-203834

Patent Document 3: Japanese Patent Laid-Open No. 2001-253709

### DISCLOSURE OF THE INVENTION

### Problems to be Solved by the Invention

However, recently, due to the rapid developments in making devices such as precision electronic devices and the like smaller and thinner, a polishing performance is required which is not only prevents polishing scratches from forming, but also has a small surface roughness of the polishing surface and has a very high smoothness. Thus, even the cerium oxides with a relatively small particle size described in Patent Documents 1 to 3 cannot be said to be an abrasive having polishing properties which are sufficiently satisfactory.

On the other hand, colloidal silica, in which silica (silicon dioxide) is dispersed in a solvent, is also known as an abrasive which realizes a high level of smoothness. However, such colloidal silica tends to strongly adhere to the polishing surface, so that if it is exposed to air even for a short time during the polishing, it is difficult to completely remove even by cleaning. Further, silica also tends to have a small polishing rate.

Further, for ultraviolet absorber applications, there is a need for further improvements in the ultraviolet ray blocking efficiency and visible light transmittance. In addition, as a supported medium for catalyst, there is a need to have a high degree of dispersion without the precious metal and the like of the catalyst particles agglomerating even when a high-temperature heat treatment is performed.

Therefore, the present invention relates to a cerium oxide with a controlled particle size. More specifically, the present invention provides a cerium oxide having a good balance among polishing surface precision, polishing rate, and cleaning properties of the polishing surface when used as an abrasive. Specifically, the present invention relates to a cerium oxide which, while realizing high smoothness comparable to that of colloidal silica, has a large polishing rate and good cleaning properties of the polishing surface after polishing, when used as an abrasive. Further, the present invention provides a method for producing such a cerium oxide. In addition, the present invention provides a cerium oxide which is suitable as an ultraviolet absorber or as a supported medium for catalyst.

### Means for Solving the Problems

To solve the above-described problems, the present inventors carried out intensive investigations concerning cerium oxides which, while suppressing the formation of polishing scratches by using a cerium oxide having a relatively small average particle size, also had a large polishing rate and good cleaning properties. Further, by considering the behavior and the like of dispersed particles in a state where the cerium oxide during polishing is a slurry, the present inventors thought that they could realize the above-described polishing performance. As a result, when the present inventors focused on sedimentation volume, which arises from the interaction among the dispersed particles in the slurry, they discovered that for a slurry in which aqueous brine is used as the solvent, the abrasive has a large polishing rate and also good cleaning properties if the cerium oxide settles out at a predetermined sedimentation volume level and they completed the present invention.

Specifically, the present invention relates to a cerium oxide having an average particle size of 0.5 μm or less and a crystallite diameter of 8 nm to 80 nm, characterized in that the cerium oxide settles out in 3 mass % aqueous brine to a predetermined sedimentation volume when the cerium oxide is formed as a slurry containing cerium oxide in a concentration of 2 mass %, and the sedimentation volume after leaving the cerium oxide slurry to stand for 24 hours after stirring is 2.5 to 15.0 mL/g.

The cerium oxide of the present invention has a relatively small particle size with an average particle size of 0.5 μm or less and a crystallite diameter of 8 nm to 80 nm, and a sedimentation volume in aqueous brine within the above-described range. As a result, the cerium oxide of the present invention can realize a polished surface with a high smoothness and be used as an abrasive having an excellent polishing performance, with a good polishing rate and good cleaning properties.

Generally, a cerium oxide having a small average particle size has good dispersibility, so that when such a cerium oxide is formed as a slurry, the cerium oxide tends not to settle out. This is also the case when the cerium oxide of the present invention is formed as a slurry. In an aqueous solution free from brine, the cerium oxide does not easily sediment even when a dispersant for preventing sedimentation is not used. However, the present inventors discovered that a cerium oxide which exhibits a behavior in which, when a cerium oxide slurry containing cerium oxide in a concentration of 2 mass % is formed in 3 mass % aqueous brine, the sedimentation volume after 24 hours is 2.5 to 15.0 mL/g, is an abrasive having a large polishing rate and which does not easily adhere to the polishing surface, while realizing high smoothness.

While the details as to why the polishing performance improves are not clear, it is thought that the performance improves due to the agglomeration state of the particles dispersed in the solvent and the sedimentation volume arising from the interaction among the dispersed particles and the like, are in a preferred range for polishing. For example, for the cerium oxide of the present invention, it is thought that a high polishing rate is realized as a result of self-weight consolidation and stress consolidation caused by interaction among the particles during polishing.

If the sedimentation volume is less than 2.5 mL/g, although the polishing rate increases, the smoothness of the polishing surface tends to decrease. If the sedimentation volume is more than 15.0 mL/g, the abrasive tends to adhere to the polishing surface, and the polishing rate tends to decrease. The sedimentation volume is preferably 2.5 to 7.0 mL/g. This is because it is easier to maintain a high polishing rate if the sedimentation volume is 7.0 mL/g or less.

Further, in the present invention, the sedimentation volume refers to the bulk volume of the settled particles after charging the cerium oxide slurry into a 100 mL color comparison tube, stirring, and then leaving to stand for 24 hours. The units are expressed as bulk volume (mL/g) of particles after sedimentation with respect to 1 gram of cerium oxide (including the solid abrasive grains in the slurry).

Concerning the cerium oxide of the present invention, the reason why the average particle size was specified in the above manner is that polishing scratches from coarse particles tend to form if the average particle size exceeds 0.5 μm. Further, the average particle size is preferably 0.07 μm or more. If the average particle size is less than 0.07 μm, during polishing, it tends to be difficult to obtain the consolidation effects resulting from the interaction among the particles, adhesiveness with the polishing surface tend to improve, and the polishing rate tends to decrease.

Further, if the crystallite diameter is less than 8 nm, a large amount of unreacted cerium ions tends to be captured in the agglomerated particles in the slurry. During polishing, these cerium ions act as a binder, whereby the adhesive force of the agglomerated particles on the glass surface tends to become stronger. As a result, the polishing rate may decrease. Further, if the crystallite diameter is more than 80 nm, so that the average particle size and the crystallite diameter are the same, the cerium oxide becomes a single crystal, and polishing scratches tend to form.

Looking at the relationship between average particle size and crystallite diameter, a ratio (A/B) between average particle size (A) and crystallite diameter (B) is preferably 2.0 to 15.0. If A/B is less than 2.0, the cerium oxide particles resemble single crystal particles having an angular shape. During polishing, stress is concentrated on the edge portions of the angular particles, so that polishing scratches tend to form. On the other hand, if A/B is more than 15.0, the viscosity of the agglomerated particles tends to increase, so that the adhesive force of the abrasive on the polishing surface tends to become stronger due to the pressure which the abrasive applies during polishing. Further, unevenness tends to occur in the adhesion of the abrasive to the polishing surface, uneven portions with a depth of a few nanometers and a width of about 200 nm can form, undulations can increase in size, and the polishing surface tends to become cloudy.

Here, in the present invention, the average particle size is expressed as a D₅₀ value of 50% of the cumulative volume from the smaller particle size side and when measured by particle size distribution by the laser diffraction and scattering method (refer to JIS R 1629-1997 “Method for Measuring Particle Size Distribution of Fine Ceramic Raw Materials by Laser Diffraction Scattering”. The crystallite diameter is based on a value measured by X-ray powder diffraction analysis.

Further, while the cerium oxide of the present invention may be used for an abrasive as is, it may also be used as a slurry state. For example, a slurry state is usually formed by charging the cerium oxide into pure water. A dispersant for preventing sedimentation may also be used together with the cerium oxide. Examples of dispersants which may be used include polystyrene sulfonic acid, polyoxyethylene sorbitan fatty acid ester, pyrophosphoric acid which is a condensed phosphoric acid, tripolyphosphoric acid, hexametaphosphoric acid, polyacrylic acid, polymaleic acid, acrylic acid-maleic acid copolymer, acrylic and the like, which are polycarboxylic acid type polymer compounds, and the respective salts thereof.

The cerium oxide of the present invention can be produced by a method for producing cerium oxide from cerium(III) hydroxide, the method including a step of producing cerium(III) hydroxide by reacting cerium chloride and an alkaline substance at a solution temperature of 60° C. to 104° C. and a pH of 5 to 9, and a step of producing cerium oxide by oxidizing the cerium hydroxide with an oxidizing agent. Here, “(III)” indicates that the cerium has a valency of three.

The reaction for producing the cerium(III) hydroxide uses cerium chloride for a raw material. If some other raw material is used, such as cerium nitrate or ammonium cerium nitrate, the average particle size tends to increase. If the pH during the reaction is less than 5, the average particle size tends to increase. If the pH during the reaction is more than 9, the crystallite diameter tends to decrease. Further, if the solution temperature during the reaction is less than 60° C., the crystallite diameter tends to decrease, while if the solution temperature during the reaction is higher than 104° C., warming under pressure is necessary, which can cause the cerium oxide to elute or recrystallize. As a result, the particles can grow into angular particles, so that polishing scratches tend to form when the resultant product is used as an abrasive.

In the reaction for producing the cerium(III) hydroxide, it is preferred to charge the cerium chloride and the alkaline substance into the solvent while keeping the respective addition rates constant. For example, it is preferred to carry out the reaction by a method in which the cerium chloride and the alkaline substance are simultaneously added dropwise into the solvent, or a method in which the cerium chloride and the alkaline substance are brought into contact with each other, and then the resultant product is immediately sheared.

According to the above-described methods, gelation during the reaction can be suppressed, and the cerium(III) hydroxide can be produced in a uniform shape. Thus, the oxidation step tends to proceed uniformly, so that a cerium oxide with a uniform particle size and a small average particle size can be obtained. When this cerium oxide is used as an abrasive, the polishing can be carried out uniformly on the polishing surface, so that the polishing surface precision can be improved. Further, examples of the alkaline substance which can be used include alkali metal hydroxides such as sodium hydroxide and potassium hydroxide, ammonium and the like, as well as an aqueous solution thereof.

In the case of carrying out the reaction by simultaneously adding dropwise the cerium chloride and the alkaline substance into the solvent, it is preferred to react by adding both the reagents in small amounts. This is because if a large amount is added all at once, the reaction in the solution tends not to easily proceed uniformly, and gelation can occur. Water is preferably used as the solvent at this stage.

Further, according to the method in which the cerium chloride and the alkaline substance are brought into contact with each other, and then the resultant product is immediately sheared, the progress of the reaction can be accelerated. Shearing refers to causing a force to act so that the liquid is deformed in a different direction with respect to the supply direction of the liquid as when an object is cut into two by a pair of scissors. The shearing may be carried out using a homogenizer, a disperser and the like. For example, the method may be carried out by adding the cerium chloride and the alkaline substance in constant amounts at a rate so that they come into contact with each other, and before the pH changes from the reaction progressing, injecting the solution into the inner side of a rotating shearing apparatus. After the solution hits the rotor teeth, the solution is discharged from the apparatus by centrifugal force. By providing an anchor tooth (stator) having a different number of teeth as the rotor on the external side of the shearing apparatus, a strong shearing force can be applied on the solution. Especially, if a rotor or a stator capable of stirring at a high shearing rate is used, the progress of the reaction can be accelerated even more.

Further, the thus-obtained cerium(III) hydroxide is used to produce the cerium oxide by oxidizing with an oxidizing agent. If an oxidizing agent is used, the polishing rate can usually be larger when used as an abrasive compared with when the oxidation is carried out by rapid heating, air oxidation or the like. Further, examples of oxidizing agents which can be used include hydrogen peroxide water, hypochlorous acid, sodium hypochlorite, potassium hypochlorite, calcium hypochlorite, ozone and the like.

The solution temperature during the oxidation is preferably 80° C. or more at atmospheric pressure, and 90° C. or more is more preferable. If the solution temperature is less than 80° C., the oxidation reaction may not progress easily. If the solution temperature is 70° C. or less, it is difficult for the oxidation reaction to progress completely, which tends to make it difficult to produce an abrasive with a high polishing rate. In the case of carrying out the oxidation reaction by heating under an atmosphere exceeding atmospheric pressure, the oxidizing agent hydrogen peroxide is degraded by the heat. The produced oxygen is used in the oxidation reaction, and coarse particles tend to form.

The cerium(III) hydroxide obtained by the reaction of the cerium chloride and the alkaline substance is preferably cleaned. Further, it is also preferred to clean the cerium oxide after oxidation. By cleaning, the cerium oxide particle distribution tends to be sharper and the average particle size also tends to be smaller. The cleaning may be carried out by a method such as filtration, centrifugal separation, filter-pressing and the like. For example, a preferred method is to carry out circulation cleaning while discharging a filtrate obtained by filtration. This is because the cleaned slurry concentration can be adjusted.

### BRIEF DESCRIPTION OF THE DRAWINGS

FIG. 1 is a flow diagram of the method for producing the cerium oxide of Examples 1 to 4;

FIG. 2 is a flow diagram of the method for producing the cerium oxide of Examples 5 to 9;

FIG. 3 is a TEM observation photograph (left, Example 9; right, Example 1);

FIG. 4 is a TEM observation photograph (Comparative Example 6);

FIG. 5 is a TEM observation photograph (Comparative Example 7);

FIG. 6 is a particle distribution map (left, Example 1; right, Comparative Example 7);

FIG. 7 is an observation photograph of sedimentation volume (from the left, NaCl not added Example 1, NaCl added Example 12, Comparative Example 10, and Example 11);

FIG. 8 is an observation photograph of sedimentation volume (left, Example 1; right, Comparative Example 7); and

FIG. 9 is a graph showing cerium oxide light transmittance (Sample A: Example 1; Sample B: Commercially-available product).

### BEST MODE FOR CARRYING OUT THE INVENTION

The preferred embodiments of the present invention will be described, hereinafter.

### Embodiment 1

In this embodiment, the cerium oxides obtained from various production methods were evaluated.

### Example 1

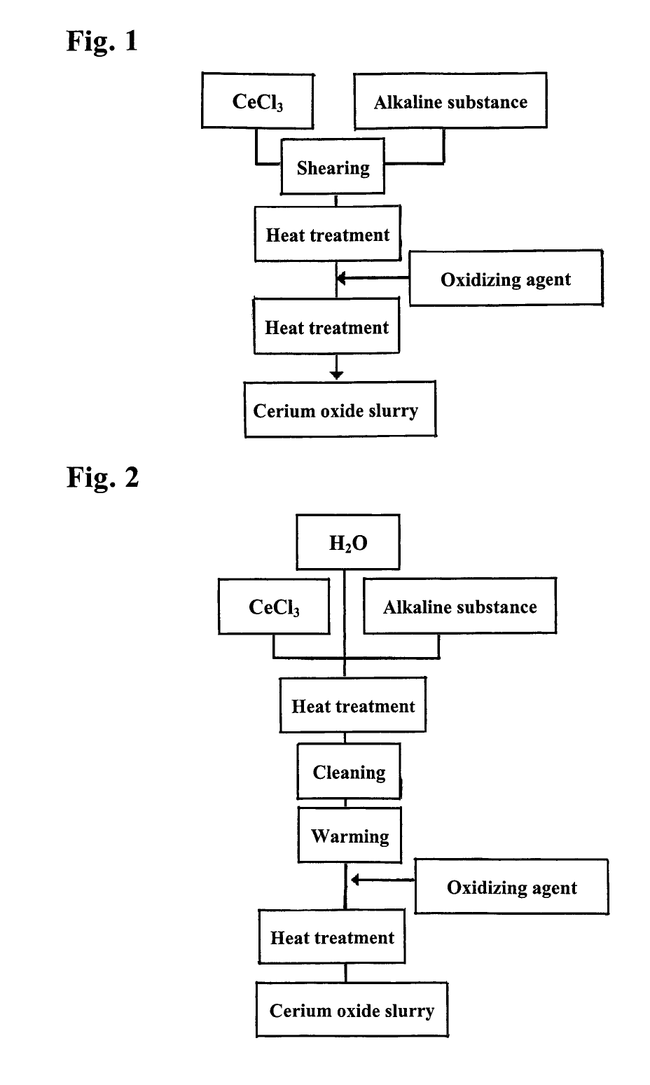

In conformity to the flow shown in FIG. 1, cerium chloride and an alkaline substance were brought into contact with each other, and the resultant product was immediately sheared. The obtained hydroxide was oxidized with an oxidizing agent, and then the resultant material was cleaned to produce cerium oxide. The reaction was carried out by contacting 2.5 L of an aqueous cerium chloride solution (cerium concentration adjusted to 120 g/L in terms of cerium oxide) and 2.5 L of an 83.66 g/L aqueous sodium hydroxide solution at flow rates of respectively 100 mL/min at 90° C. and a pH of 6.0, then immediately shearing the resultant product. The shearing was carried out by a disperser at a high shearing rate of 10³ sec⁻¹ or more.

Then, the sediment produced in the solution was identified as cerium(III) hydroxide by X-ray diffraction analysis (XRD). The cerium(III) hydroxide slurry was heat treated for 10 minutes or more until the pH stabilized while keeping the solution temperature at 90° C., and then 450 mL of 6 mass % hydrogen peroxide water was added dropwise at a flow rate of 3 mL/min to oxidize the cerium hydroxide. Then, the product was heat treated for 3 hours with the solution temperature kept at 90° C. to obtain a cerium oxide slurry.

The thus-obtained cerium oxide slurry (adjusted to a concentration of 5 mass %) was circulated at 120 mL/min using a cross-flow filter while stirring. The filtrate was discharged at 16 mL/min, and circulated and cleaned. The slurry was gradually concentrated until the cerium hydroxide concentration went from 5 mass % to 10 mass %, and then circulated and cleaned. Then, the slurry was again filtered until the Na⁺ ion concentration was 1,700 mg/L or less. Further, the slurry was concentrated by circulation cleaning until the concentration was 20 mass %. Then, cleaning was carried out until the Na⁺ ion concentration was 100 mg/L or less to produce a cerium oxide slurry.

### Examples 2 to 4

Cerium oxide slurries were obtained in the same manner as in Example 1, except that the solution temperature or pH at which the cerium chloride and the alkaline substance were reacted was adjusted as shown in Table 1.

### Example 5

According to the flow shown in FIG. 2, cerium chloride and sodium hydroxide were reacted in pure water by simultaneously adding them dropwise at addition rates of 5 mL/min. The obtained cerium(III) hydroxide was cleaned and then oxidized by an oxidizing agent to produce cerium oxide. The reaction was carried out by simultaneously adding dropwise, to 3 L of pure water, 1 L of an aqueous cerium chloride solution (150 g/L in terms of cerium oxide) and 1 L of a 104.58 g/L aqueous sodium hydroxide solution at a solution temperature of 60° C. and a pH of 6.0. The sediment produced by this reaction was identified as cerium(III) hydroxide by X-ray diffraction analysis (XRD).

Then, using the same filter as described above, the slurry was circulated at 120 mL/min. The filtrate was discharged at 20 mL/min, and circulated and cleaned. The slurry was concentrated by circulation cleaning until the cerium(III) hydroxide concentration went from 5 mass % to 15 mass %. Then, the slurry was again filtered until the Na⁺ ions were 1,500 mg/L or less. Further, the slurry was circulated and cleaned until the cerium(III) hydroxide concentration was 30 mass %, and the cleaning was carried out until the Na⁺ ions were 100 mg/L or less.

Next, the reaction solution was warmed to 90° C., and then 225 mL of 6 mass % hydrogen peroxide water was added dropwise to oxidize the cerium(III) hydroxide. The product was then heat treated for 3 hours with the solution temperature kept at 90° C. to obtain a cerium oxide slurry.

### Examples 6 to 9 and Comparative Examples 1 to 3

Cerium Oxide slurries were obtained in the same manner as in Example 5, except that the solution temperature or pH at which the cerium chloride and the sodium hydroxide were reacted was changed. In Example 7, instead of sodium hydroxide, 1 L of ammonia water with a concentration of 44.53 g/L was used.

### Comparative Example 4

A cerium oxide slurry was obtained in the same manner as in Example 5, except that 1 L of an aqueous cerium nitrate solution (150 g/L in terms of cerium oxide) was used instead of the cerium chloride.

### Comparative Example 5

Cerium oxide and sodium hydroxide were reacted, and the resultant product was then cleaned. Then, steam was directly charged into the reaction solution to rapidly heat the solution to 90° C. so that the cerium(III) hydroxide was physically oxidized. Then, the product was heat treated for 3 hours with the solution temperature kept at 90° C. to obtain a cerium oxide slurry. As for the other conditions, the same method as Example 5 was used.

### Comparative Example 6

Cerium oxide was produced according to the method described in Patent Document 1. 1 L of a 1 mol/L aqueous cerium nitrate solution (172.12 g/L in terms of cerium oxide) and 1 L of 3 mol/L (51.09 g/L) ammonia water were charged all at once into a 3 L vessel. The resultant solution was stirred for 5 minutes at 500 pm using a stirrer to produce a sediment of cerium hydroxide. The pH of this mixed solution was 9. When measured by XRD, the obtained sediment was identified as cerium(IV) hydroxide. Next, steam was directly charged into the vessel to increase the temperature to 100° C. in 3 minutes. The product was held for 1 hour with the solution temperature kept at 100° C. Then, decantation was repeated 5 times to obtain a cerium oxide slurry.

### Comparative Example 7

In addition to the cerium oxides of the above-described examples and comparative examples, for comparison, the following measurements were also carried out on colloidal silica (COMPOL 80, manufactured by Fujimi Incorporated).

### <TEM Surface Observation>

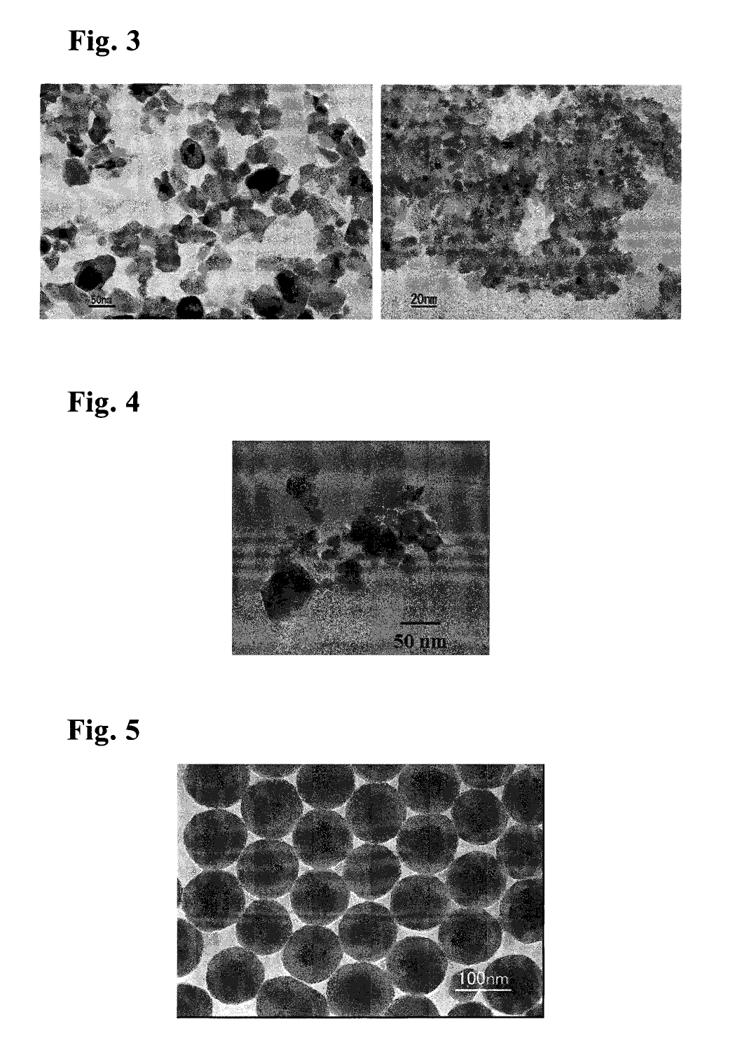

The shape of the cerium oxides obtained by the above-described methods and the colloidal silica of Comparative Example 7 was observed using a scanning electron microscope (TEM). TEM observation photographs are shown in FIGS. 3 to 5.

According to the TEM observation photograph of FIG. 3, it can be seen that the cerium oxide of Example 1 (right), which was obtained by shearing immediately after bringing the cerium chloride and the alkaline substance into contact with each other, has more uniform fine particles than the cerium oxide of Example 9 (left). Further, the cerium oxide of Comparative Example 6, in which the cerium hydroxide was rapidly heated, has a greater unevenness in particle size than the cerium oxide of the examples (FIG. 4). The colloidal silica of Comparative Example 7 had an approximately spherical shape (FIG. 5), and no angular shapes like the cerium oxide of the examples were seen.

### <Average Particle Size D₅₀>

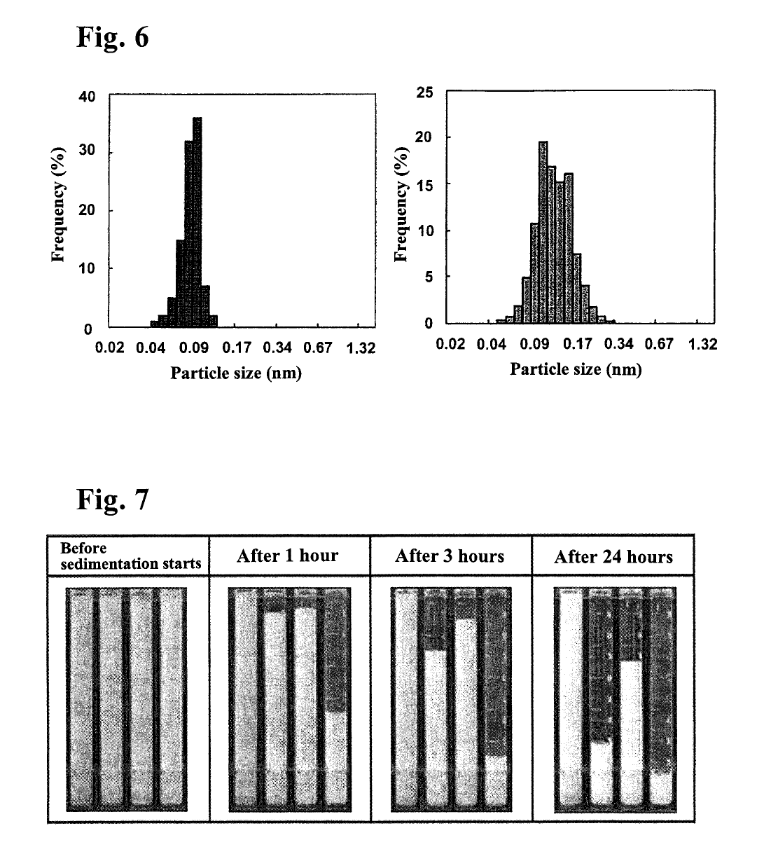

Average particle size (D₅₀: particle size at the cumulative mass 50 mass % from the smaller particle size side) was determined by measuring the particle size distribution using a laser diffraction scattering method particle size distribution analyzer (LA-920, manufactured by HORIBA, Ltd.). The measurement results for Example 1 and Comparative Example 7 are shown in FIG. 6.

### <Crystallite Diameter>

The crystallite diameter was determined by X-ray diffraction analysis (XRD) using an automatic X-ray diffraction analyzer. For the X-ray source, measurement was carried out across the range of 5°≦2θ≦90° using a copper target. The crystallite diameter was calculated from a least-square method according to the Willson method based on peak values of 2θ=28.5°, 33.1°, 47.5°, and 56.4°.

TABLE 1

| | | | | | | Average | | |
|---|---|---|---|---|---|---|---|---|
| | | | Solution | | | Particle | Crystallite | |
| | Raw | Alkaline | temperature | | Oxidation | Size A | Diameter B | |
| | Material | Substance | [° c.] | pH | Method | [μm] | [nm] | A/B |
| Example 1 | c | s | 90 | 6.0 | Hydrogen | 0.094 | 18.7 | 5.0 |
| Example 2 | | | 60 | | Peroxide | 0.076 | 8.2 | 9.3 |
| Example 3 | | | 90 | 9.0 | | 0.087 | 12.4 | 7.0 |
| Example 4 | | | 104 | 6.0 | | 0.142 | 20.5 | 6.9 |
| Example 5 | c | s | 60 | 6.0 | Hydrogen | 0.122 | 9.8 | 12.4 |
| Example 6 | | | 90 | | Peroxide | 0.217 | 45.1 | 4.8 |
| Example 7 | | a | | | | 0.206 | 62.7 | 3.3 |
| Example 8 | | s | | 9.0 | | 0.314 | 24.3 | 12.9 |
| Example 9 | | | 102 | 6.0 | | 0.493 | 78.9 | 6.2 |
| Comparative | c | s | 90 | 3.0 | Hydrogen | 3.265 | 77.2 | 42.3 |
| Example 1 | | | | | Peroxide | | | |
| Comparative | | | | 11.0 | | 0.178 | 6.2 | 12.6 |
| Example 2 | | | | | | | | |
| Comparative | | | Room | 6.0 | | 0.109 | 6.7 | 16.3 |
| Example 3 | | | Temperature | | | | | |
| Comparative | n | s | 90 | 6.0 | Hydrogen | 0.847 | 22.6 | 37.5 |
| Example 4 | | | | | Peroxide | | | |
| Comparative | c | | | | Rapid | 0.756 | 16.3 | 46.4 |
| Example 5 | | | | | Heating | | | |

Raw Material c: Cerium Chloride, n: Cerium Nitrate
Alkaline Substance s: Sodium Hydroxide, a: Ammonia

The cerium oxides of Examples 1 to 9, which were produced by reacting cerium chloride and an alkaline substance at a temperature of 60° C. to 104° C. and a pH of 5 to 9, had an average particle size of 0.5 μm or less, and a crystallite diameter within the range of 8 to 80 nm. From the particle size distribution charts of FIG. 6, the cerium oxide on the left of FIG. 6 (Example 1) showed a sharper particle size distribution than that for the colloidal silica (Comparative Example 7) on the right of FIG. 6. Further, when a method was used in which the shearing was carried out immediately after bringing the cerium oxide and the alkaline substance into contact with each other (Examples 1 to 4), cerium oxide having a smaller average particle size tended to be obtained compared with when these were simultaneously added (Examples 5 to 9). The higher the temperature was during the reaction, the larger the average particle size and crystallite diameter tended to become.

On the other hand, the average particle size of the cerium oxide in Comparative Example 1, in which the pH was 3.0, was very large. The crystallite diameter of the cerium oxide in Comparative Example 2, in which the pH was 11.0, and in Comparative Example 3, in which the reaction was carried out at room temperature, was less than 8 nm. Further, in Comparative Example 4, in which cerium nitrate was used as a raw material instead of cerium chloride, and in Comparative Example 5, in which the cerium hydroxide was oxidized by rapid heating, the average particle size was relatively large.

Further, for the cerium oxide of Comparative Example 6, which was obtained by the production method described in Patent Document 1, the average particle size was 2.599 μm and the crystallite diameter was 18.7 nm. The colloidal silica of Comparative Example 7 had an average particle size of 0.103 μm.

### Embodiment 2

In addition to the thus-obtained cerium oxides of the examples and the comparative examples, the cerium oxides obtained by the following production method underwent sedimentation volume measurement and a polishing performance evaluation.

### Example 10

According to the flow shown in FIG. 2, 3 L of pure water was heated to 90° C., and then 1 L of an aqueous cerium chloride solution (250 g/L in terms of cerium oxide) and 1 L of a 174.3 g/L aqueous sodium hydroxide solution were simultaneously added dropwise at an addition rate of 5 mL/min, and the resultant mixture was reacted at a pH of 5.6. Then, the mixture was heat treated at a solution temperature of 90° C. for 20 minutes or more. Then, 375 mL of 6 mass % hydrogen peroxide water was added dropwise at a flow rate of 3 mL/min to oxidize the cerium(III) hydroxide. The mixture was heat treated for 1 hour with the solution temperature kept at 90° C., and then filtered with a cross-flow filter. The resultant filtrate was cleaned in the same manner as in Example 1 to obtain a cerium oxide slurry.

### Example 11

Cerium(III) hydroxide was obtained in the same manner as in Example 6. Then, 750 mL of 3 mass % hydrogen peroxide water was added at a flow rate of 1 mL/min to oxidize the cerium(III) hydroxide. The resultant mixture was heat treated for 3 hours with the solution temperature kept at 90° C., and then filtered with a cross-flow filter. The resultant filtrate was cleaned in the same manner as in Example 1 to obtain a cerium oxide slurry.

### Example 12

According to the flow shown in FIG. 2, 3 L of pure water was heated to 90° C., and then 1 L of an aqueous cerium chloride solution (180 g/L in terms of cerium oxide) and 1 L of a 125.5 g/L aqueous sodium hydroxide solution were simultaneously added dropwise at an addition rate of 100 mL/min, and the resultant mixture was reacted at a pH of 8.8. The obtained cerium(III) hydroxide was filtered with No. 2 filter paper using a pressure filter whose pressure had been adjusted to 0.06 MPa with nitrogen gas. The pressure filtration and cleaning were repeated while supplying pure water until the Na⁺ ion concentration was 300 mg/L or less. After the cleaning, the mixture was heat treated at a solution temperature of 90° C. for 20 minutes or more. Then, 270 mL of 6 mass % hydrogen peroxide water was added dropwise at a flow rate of 3 mL/min to oxidize the cerium hydroxide. The mixture was heat treated for 1 hour with the solution temperature kept at 90° C. to obtain a cerium oxide slurry.

### Example 13

According to the flow shown in FIG. 2, 3 L of pure water was heated to 90° C., and then 1 L of an aqueous cerium chloride solution (250 g/L in terms of cerium oxide) and 1 L of a 174.3 g/L aqueous sodium hydroxide solution were simultaneously added dropwise at an addition rate of 100 mL/min, and the resultant mixture was reacted at a pH of 9.0. Then, the mixture was heat treated at a solution temperature of 90° C. for 20 minutes or more. Then, 375 mL of 6 mass % hydrogen peroxide water was added dropwise at a flow rate of 3 mL/min to oxidize the cerium hydroxide. The obtained cerium oxide was subjected to pressure filtration and cleaning in the same manner as in Example 12. After the cleaning, the mixture was heat treated for 1 hour with the solution temperature kept at 90° C. to obtain a cerium oxide slurry.

### Comparative Example 8

Cerium Carbonate Obtained by Reacting cerium nitrate and ammonium bicarbonate was sintered, and then turned into a slurry. Slurry containing only particles having a particle size of 0.5 μm or less based on the Stokes equation was extracted to obtain a cerium oxide slurry.

When 1 L of a 1 mol/L aqueous cerium nitrate solution (172.12 g/L in terms of cerium oxide) was added dropwise to 3.6 L of 2 mol/L (158.12 g/L) ammonium bicarbonate water while stirring at 500 rpm, a cerium carbonate sediment was produced. The pH of this mixed solution was 7.8. Cleaning by decantation was repeated 5 times, and then the cerium carbonate was recovered. This cerium carbonate was dried for 3 hours at 150° C., and then calcined for 3 hours at 300° C. in air. Then, the resultant product was pulverized by a juicer mixer and passed through a sieve having 75 μm apertures to recover 120 g of particles. These particles were sintered for 3 hours in air at 1,000° C. After sintering, the sintered product was passed through a sieve having 75 μm apertures to recover 80 g of the sintered product, which was then charged with pure water to adjust to a 1 L slurry, and this slurry was stirred for 5 minutes at 500 rpm using a compact stirrer.

The stirred slurry was left to stand for 6 hours. Then, the slurry from the upper part of the slurry surface which had been calculated from the Stokes equation to contain particles of 0.5 μm or less to a depth of 179 mm (600 mL) was extracted by a siphoning principle. Then, after the addition of pure water, stirring, leaving to stand, and extracting slurry were again repeated, and the resultant product was circulated at 120 mL/min using a cross-flow filter while stirring. Then, while discharging the filtrate at 25 mL/min, the product was concentrated until the cerium oxide concentration was 15 mass % to obtain a cerium oxide slurry.

### [Stokes Equation]

In the equation, calculation was carried out based on a cerium oxide particle density ρ₁ of 7.1 g/cm³, a water density ρ₂ of 1.00 g/cm³, a gravitational acceleration g of 9.8 m/s², a water viscosity η of 1.0 cp. Further, the cerium oxide having a particle size of 0.5 μm or less was assumed to settle out at 0.498 mm/min. According to this calculation, after 6 hours, 179 mm sediments. Thus, in the above method, the slurry from the top of the liquid surface to 179 mm down was extracted.

### [Equation 1]

U=D×D(ρ₁−ρ₂)g/18η Stokes Equation

wherein, U represents the particle sedimentation rate (m/s), D represents the particle size (m), ρ₁ represents the density of the particles (kg/m³), ρ₂ represents the density of the dispersion medium (kg/m³), g represents the gravitational acceleration [m/s²], and η represents the viscosity of the dispersion medium (Pa·s).

### Comparative Example 9

The same method as in Comparative Example 8 was used, except that the sintering temperature was 1,300° C. and a sedimentation classification treatment based on the Stokes equation was not carried out. Here, after the sintering, the amount of particles which passed through the sieve was 30 g.

### Comparative Example 10

A cerium(IV) hydroxide sediment was produced by heating 2.5 L of an aqueous cerium nitrate solution (120 g/L in terms of cerium oxide) and 2.5 L of a 83.66 g/L aqueous sodium hydroxide solution respectively to 90° C., and then charging the aqueous sodium hydroxide solution all at once into the aqueous cerium chloride solution, and stirring the resultant mixture for 20 minutes at 600 rpm with a stirrer. The pH of this mixed solution was 12.5. Air was injected into the obtained cerium(IV) hydroxide slurry for bubbling, and an oxidation treatment was carried out for 1 hour at a solution temperature of 90° C. to obtain cerium oxide.

### <Sedimentation Volume>

200 mL of a cerium oxide slurry having 2.5 mass % of cerium oxide was weighed, and charged with an aqueous NaCl solution (brine) to adjust the cerium oxide concentration to 2.0 mass % and the NaCl concentration to 3.0 mass %. The concentration-adjusted sample was charged into a 250 mL plastic, wide-neck bottle equipped with a lid. The contents were then stirred by shaking the bottle for 10 minutes with a paint shaker. 100 mL of the stirred sample was charged into a color comparison tube and left to stand for 24 hours at room temperature. The sedimentation volume was calculated from the reading of the color comparison tube and from of the product of the value of the bulk height of the settled particles measured by a stainless steel ruler and the inner diameter of the color comparison tube. The sedimentation volumes of a slurry adjusted to have a cerium oxide concentration of 10 mass % and a slurry adjusted to have a dispersant concentration of 0.5 mass % were similarly measured under the same conditions such as brine concentration and the like. The results are shown in Table 2.

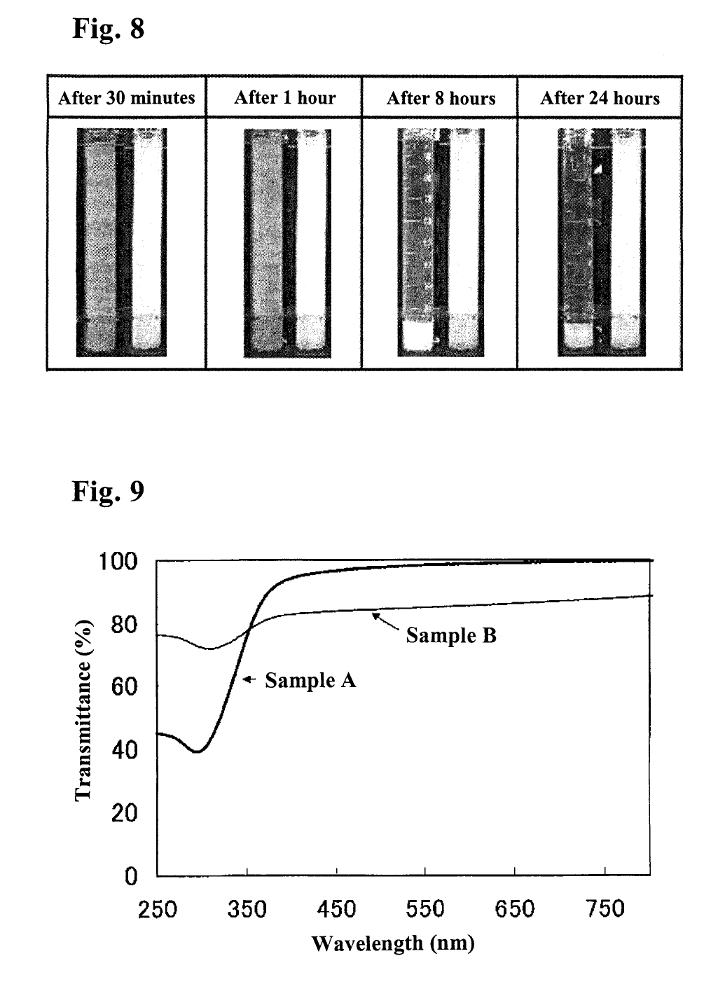

FIGS. 7 and 8 illustrate observation photographs of the sedimentation behavior over the 24 hours of the sedimentation test. In FIG. 7, on the far left side is an observation of the sedimentation behavior of the cerium oxide of Example 1 in pure water free from brine. The other observations are of the sedimentation behavior of the cerium oxides of Example 12, Comparative Example 10, and Example 11 in aqueous brine. From the figures, it can be seen that although hardly any sedimentation of the cerium oxide of Example 1 which was free from brine was observed even after 24 hours, for the cerium oxides of the other examples, a respective certain sedimentation volume in the aqueous brine was observed. Further, FIG. 8 is an observation of the sedimentation behavior, in aqueous brine, of cerium oxide of Example 1 and the colloidal silica of Comparative Example 7. The left side of FIG. 8 shows that the cerium oxide of Example 1 has ⅓ of its bulk volume after 24 hours, while the right side of FIG. 8 shows that no sedimentation of the colloidal silica of Comparative Example 7 was observed even after 24 hours.

TABLE 2

| | | | | Sedimentation Volume [mL/g] | | | |
|---|---|---|---|---|---|---|---|
| | Average | | | Cerium Oxide | | | Cerium Oxide |
| | Particle | Crystallite | | Concentration 2 wt. % | | | Concentration 10 wt. % |
| | Size A | Diameter B | | No | 0.5 wt. % Sodium | 0.5 wt. % Sodium | 0.5 wt. % Sodium |
| | [μm] | [μm] | A/B | Additives | Hexametaphosphate | Pyrophosphate | Hexametaphosphate |
| Example 1 | 0.094 | 18.7 | 5.0 | 5.1 | 5.0 | 5.3 | 4.7 |
| Example 2 | 0.076 | 8.2 | 9.3 | 5.8 | 5.6 | 5.7 | 5.1 |
| Example 3 | 0.087 | 12.4 | 7.0 | 6.0 | 5.7 | 5.8 | 5.3 |
| Example 4 | 0.142 | 20.5 | 6.9 | 4.5 | 4.5 | 4.4 | 4.3 |
| Example 5 | 0.122 | 9.8 | 12.4 | 6.0 | 5.8 | 5.9 | 5.2 |
| Example 6 | 0.217 | 45.1 | 4.8 | 4.8 | 4.6 | 4.8 | 4.1 |
| Example 7 | 0.206 | 62.7 | 3.3 | 5.2 | 5.1 | 5.0 | 4.7 |
| Example 8 | 0.314 | 24.3 | 12.9 | 5.7 | 5.5 | 5.8 | 5.2 |
| Example 9 | 0.493 | 78.9 | 6.2 | 4.2 | 4.2 | 4.1 | 4.1 |
| Example 10 | 0.122 | 46.8 | 2.6 | 2.5 | 2.7 | 2.8 | 2.5 |
| Example 11 | 0.122 | 34.2 | 3.6 | 7.0 | 7.6 | 7.4 | 6.3 |
| Example 12 | 0.122 | 10.8 | 11.3 | 14.5 | 12.5 | 13.0 | 11.5 |
| Example 13 | 0.128 | 8.7 | 14.7 | 15.0 | 14.8 | 13.5 | 14.2 |
| Comparative | 0.178 | 6.2 | 12.6 | 18.6 | 18.8 | 18.4 | 18.3 |
| Example 2 | | | | | | | |
| Comparative | 0.109 | 6.7 | 16.3 | 17.8 | 17.8 | 18.0 | 17.3 |
| Example 3 | | | | | | | |
| Comparative | 0.103 | — | — | 50.0 | 50.0 | 50.0 | 10.0 |
| Example 7 | | | | | | | |
| Comparative | 0.122 | 72.6 | 1.7 | 2.3 | 1.9 | 2.1 | 1.7 |
| Example 8 | | | | | | | |
| Comparative | 11.879 | 138.2 | 86.0 | 1.7 | 1.6 | 1.7 | 1.5 |
| Example 9 | | | | | | | |
| Comparative | 1.661 | 6.4 | 259.5 | 34.0 | 38.5 | 37.5 | 36.0 |
| Example 10 | | | | | | | |

From the table, it can be seen that regardless of whether a dispersant is added or not, the cerium oxides of Examples 1 to 13 all have a sedimentation volume in the range of 2.5 to 15.0 mL/g for a cerium oxide concentration of 2 mass %.

On the other hand, the colloidal silica of Comparative Example 7 had a very large sedimentation volume. Further, for Comparative Example 8, in which a sedimentation classification treatment based on the Stokes equation was carried out, although cerium oxide having an average particle size of 0.5 μm was obtained, the sedimentation volume was less than 2.5 mL/g. In Comparative Example 9, in which the sintering temperature was higher than in Comparative Example 8, the cerium oxide had a relatively large average particle size, and the sedimentation volume was also less than 2.5 mL/g.

### <Polishing Method>

Using a single side polishing tester, a polishing target surface was polished with a polishing pad while supplying a slurry-like abrasive onto the polishing target surface. Only water was used as the dispersion medium, and the abrasive grain concentration of the abrasive slurry was made to be 10 mass %. In the present polishing test, an abrasive slurry adjusted to 10 mass % by adding pure water to the obtained cerium oxide slurry was supplied and circulated at a rate of 70 mL/min. The polishing treatment was carried out for 30 minutes with a pressure of the polishing pad against the polishing surface of 5.88 kPa (60 gf/cm²) and a polishing tester peripheral speed of 50 m/min. Further, the polishing target was a flat panel glass with a diameter of 50 mm. The polishing pad was made of suede.

### <Polishing Rate>

The polishing rate was evaluated based on the rate of decrease in the glass total amount due to the polishing by measuring the glass total amount before and after the polishing. Here, the polishing rate was calculated as a relative evaluation value using Comparative Example 7 as a standard (100).

### <Polishing Scratches>

Polishing scratches were evaluated by observing the glass surface after the polishing by a reflection method using a 300,000 lux halogen lamp as a light source, and then using a system in which large scratches and fine scratches were given point values which were subtracted from a perfect score of 100 points. In this polishing evaluation, “⊚” represents a score of 98 points or more, “◯” represents a score of 95 points or more to less than 98 points, “Δ” represents a score of 90 points or more to less than 95 points, and “x” represents a score of less than 90 points.

### <Polishing Precision>

The polished surface of the glass obtained by the polishing was cleaned with pure water, dried in a dust-free state, and then evaluated for polishing precision. Surface roughness was calculated by measuring the polished surface of the glass after the polishing with an atomic force microscope (AFM) for a measurement range of 10×10 μm, and taking the average value Ra thereof. Further, fine undulations were measured by scanning the polished surface with white light at a measurement wavelength of 0.2 to 1.4 mm using a 3D surface structure analysis microscope.

TABLE 3

| | | | Surface | Fine | Sedimentation | |
|---|---|---|---|---|---|---|
| | Polishing | Polishing | Roughness | Undulations | Volume | |
| | Rate | Scratches | [nm] | [nm] | [mL/g] | A/B |
| Example 1 | 316 | ⊚ | 0.07 | 0.16 | 5.1 | 5.0 |
| Example 2 | 261 | ◯ | 0.09 | 0.20 | 5.8 | 9.3 |
| Example 3 | 303 | ⊚ | 0.06 | 0.13 | 6.0 | 7.0 |
| Example 4 | 406 | ◯ | 0.09 | 0.25 | 4.5 | 6.9 |
| Example 5 | 331 | ◯ | 0.13 | 0.17 | 6.0 | 12.4 |
| Example 6 | 532 | ⊚ | 0.08 | 0.14 | 4.8 | 4.8 |
| Example 7 | 494 | ◯ | 0.12 | 0.15 | 5.2 | 3.3 |
| Example 8 | 394 | ⊚ | 0.11 | 0.17 | 5.7 | 12.9 |
| Example 9 | 635 | ◯ | 0.14 | 0.22 | 4.2 | 6.2 |
| Example 10 | 468 | ⊚ | 0.11 | 0.18 | 2.5 | 2.6 |
| Example 11 | 342 | ⊚ | 0.08 | 0.16 | 7.0 | 3.6 |
| Example 12 | 308 | ⊚ | 0.06 | 0.12 | 14.5 | 11.3 |
| Example 13 | 284 | ⊚ | 0.06 | 0.13 | 15.0 | 14.7 |
| Comparative | 41 | ⊚ | 0.16 | 0.28 | 18.6 | 12.6 |
| Example 2 | | | | | | |
| Comparative | 38 | ⊚ | 0.23 | 0.87 | 17.8 | 16.3 |
| Example 3 | | | | | | |
| Comparative | 100 | ⊚ | 0.16 | 0.20 | 50.0 | — |
| Example 7 | | | | | | |
| Comparative | 1035 | X | 0.28 | 0.85 | 2.3 | 1.7 |
| Example 8 | | | | | | |
| Comparative | 1120 | X | 0.42 | 1.20 | 1.7 | 86.0 |
| Example 9 | | | | | | |
| Comparative | 32 | ⊚ | 0.34 | 1.15 | 34.0 | 259.5 |
| Example 10 | | | | | | |

When the cerium oxides of Examples 1 to 13 were used, it can be seen that, while maintaining a good polishing rate, there were almost no polishing scratches, there was no particularly large surface roughness or fine undulations, and the polishing surface precision was high. Especially, Examples 1 to 4, in which the cerium chloride and the alkaline substance were brought into contact with each other, and then the resultant product was immediately sheared, had a relatively low surface roughness.

On the other hand, when the colloidal silica of Comparative Example 7 was used, although the polishing surface precision was relatively high, the polishing rate was small. Further, in Comparative Examples 8 and 9, although the polishing rate was large, polishing scratches were formed, and surface roughness of the polishing surface was relatively large.

Further, for Comparative Example 8, which has a ratio (A/B) between average particle size (A) and crystallite diameter (B) of less than 2.0, polishing scratches tended to occur. For Comparative Examples 3, 9, and 10, in which A/B exceeds 15.0, surface roughness and fine undulations tended to be large. For example, comparing Comparative Examples 2 and 3, for Comparative Example 3 in which A/B exceeds 15.0, the fine undulation value was larger than for Comparative Example 2. Further, for Comparative Example 10, the polishing surface after the polishing was cloudy.

The above-described results were subjected to a comparison of the relationship between sedimentation volume and polishing performance based on the following Table 4, in which the results are extracted in order of increasing size of sedimentation volume.

TABLE 4

| | Sedimentation | Average | | | | | | |
|---|---|---|---|---|---|---|---|---|
| | Volume | Particle | Crystallite | | | | Surface | Fine |
| | (No Additives) | Size A | Diameter B | | Polishing | Polishing | Roughness | Undulations |
| | [mL/g] | [μm] | [nm] | A/B | Rate | Scratches | [nm] | [nm] |
| Comparative | 1.7 | 11.879 | 138.2 | 86.0 | 1120 | X | 0.42 | 1.2 |
| Example 9 | | | | | | | | |
| Comparative | 2.3 | 0.122 | 72.6 | 1.7 | 1035 | X | 0.28 | 0.85 |
| Example 8 | | | | | | | | |
| Example 10 | 2.5 | 0.122 | 46.8 | 2.6 | 468 | ◯ | 0.11 | 0.18 |
| Example 9 | 4.2 | 0.493 | 78.9 | 6.2 | 635 | ◯ | 0.14 | 0.22 |
| Example 7 | 5.2 | 0.206 | 62.7 | 3.3 | 494 | ◯ | 0.12 | 0.15 |
| Example 8 | 5.7 | 0.314 | 24.3 | 12.9 | 394 | ⊚ | 0.11 | 0.17 |
| Example 5 | 6.0 | 0.122 | 9.8 | 12.4 | 331 | ◯ | 0.13 | 0.17 |
| Example 11 | 7.0 | 0.122 | 34.2 | 3.6 | 342 | ⊚ | 0.08 | 0.16 |
| Example 12 | 14.5 | 0.122 | 10.8 | 11.3 | 308 | ⊚ | 0.06 | 0.12 |
| Example 13 | 15.0 | 0.128 | 8.7 | 14.7 | 284 | ⊚ | 0.06 | 0.13 |
| Comparative | 34.0 | 1.661 | 6.4 | 259.5 | 32 | ⊚ | 0.34 | 1.15 |
| Example 10 | | | | | | | | |
| Comparative | 50.0 | 0.103 | — | — | 100 | ⊚ | 0.16 | 0.20 |
| Example 7 | | | | | | | | |

From Table 4, when the cerium oxides of the Examples were used, in which the sedimentation volume was 2.5 to 15.0 mL/g, the abrasive realized high smoothness while also having a good polishing rate. On the other hand, for the cerium oxides of Comparative Examples 8 and 9, in which the sedimentation volume was less than 2.5 mL/g, although the polishing rate was large, polishing scratches tended to occur and the surface roughness was large. Further, for the cerium oxides of Comparative Examples 7 and 10, in which the sedimentation volume was more than 15.0 mL/g, although the occurrence of polishing scratches was suppressed, the polishing rate was small and the surface roughness was relatively large.

### Embodiment 3

The light transmittance of the cerium oxide obtained in Example 1 and commercially-available high-purity cerium oxide was measured.

### <Light Transmittance Measurement>

With a dispersion medium of water, a cerium oxide slurry was prepared in which 0.02 mass % of cerium oxide particles was dissolved. The light transmittance of this slurry at a wavelength of 250 to 800 nm was measured with a spectrophotometer (U-4000, manufactured by Shimadzu Corporation). The results are shown in FIG. 9. Here, sample A shows the results for when the cerium oxide of Example 1 was used, and sample B shows the results for when commercially-available high-purity cerium oxide (product name: NanoTek®, cerium(IV) oxide, manufactured by Kanto Chemical Co., Inc.) was used.

From FIG. 9, the cerium oxide of Example 1 (sample A) had good blocking efficiency of ultraviolet rays at the wavelength of 250 to 400 nm. Further, the transmittance in the visible light region of 400 to 800 nm was high. Thus, the cerium oxide of Example 1 is suitable as an ultraviolet absorber.

### Embodiment 4

Palladium, rhodium, or platinum was supported as a precious metal catalyst on the cerium oxide of Example 1, and then the degree of dispersion of the precious metal catalyst was measured. The degree of dispersion is represented as 1.00 when the precious metal particles are monodispersed at the atomic level. If the degree of dispersion is low, the precious metal particles are thought to be more coarse, so that catalytic activity tends to be low.

### <Measurement of the Degree of Dispersion>

Sample 1: Palladium nitrate (0.1 g in terms of palladium metal with respect to 1 g of cerium oxide) was adhered by dipping into the cerium oxide of Example 1. Then, the resultant product was cleaned with a cross-flow filter in the same manner as in Example 1 while measuring the NO³⁻ ion concentration to obtain a palladium-supported cerium oxide slurry concentrated to 20 mass %. 8.9 g of commercially-available alumina particles (aluminum oxide 150 basic (Type T), manufactured by Kanto Chemical Co., Inc.) was charged into 5.5 g of this slurry. The resultant product was kneaded with a three-roll roller, dried for 3 hours at 150° C., and then subjected to a heat treatment for 10 hours at 900° C. in air. Using 0.1 g of this heat-treated product (M/CeO₂/Al₂O₃), the degree of dispersion was measured by a metal degree of dispersion measurement apparatus. Further, the degree of dispersion of heat-treated products obtained using rhodium nitrate or platonic chloride instead of the palladium nitrate was also measured in the same manner. The results are shown in Table 5.

Sample 2: As a comparison, a heat-treated product (M/Al₂O₃) was obtained in which cerium oxide was not added, and palladium was supported on alumina particles only. The degree of dispersion of this heat-treated product was measured. Here, the added amount of catalyst metal was 0.1 g in terms of the metal based on 9.9 g of alumina.

Sample 3: Further, a heat-treated product (M/CeO₂/Al₂O₃) was obtained using commercially-available high-purity cerium oxide (product name: NanoTek®, cerium(IV) oxide, manufactured by Kanto Chemical Co., Inc.) instead of the cerium oxide of Example 1, and the degree of dispersion of this heat-treated product was measured. Here, the added amount of catalyst metal was 0.1 g in terms of the metal based on a total of 9.9 g of the cerium oxide and the alumina.

TABLE 5

| | Degree of Dispersion | | |
|---|---|---|---|
| | Sample 1 | Sample 2 | Sample 3 |
| | M/CeO₂/Al₂O₃ | M/Al₂O₃ | M/CeO₂/Al₂O₃ |
| Palladium | 0.31 | 0.02 | 0.01 |
| Rhodium | 0.67 | 0.08 | 0.06 |
| Platinum | 0.38 | 0.02 | 0.01 |

From Table 5, it can be seen that for Sample 1 (M/CeO₂/Al₂O₃) in which the cerium oxide of Example 1 was used as the catalyst support, the degree of dispersion was high when any of palladium, rhodium, or platinum was used, and thus since precious metal particles were highly dispersed, the cerium oxide of Example 1 is a suitable catalyst support.

### INDUSTRIAL APPLICABILITY

As described above, when used as an abrasive, the cerium oxide according to the present invention could provide a high smoothness of the polished surface, and a large polishing rate. Further, the cleaning properties after polishing were also good. In addition, the cerium oxide of the present invention is an ultraviolet absorber having a high ultraviolet blocking efficiency and a high visible light transmittance. Further, when subjected to a high temperature heat treatment, the resultant catalyst support for a catalyst has a high degree of dispersion.

1. A cerium oxide having an average particle size of 0.07 μl or more and 0.5 μm or less and a crystallite diameter of 8 nm to 80 nm, characterized in that wherein the cerium oxide settles out in 3 mass % aqueous brine to a predetermined sedimentation volume when the cerium oxide is formed as a slurry containing cerium oxide in a concentration of 2 mass %, and the sedimentation volume after leaving the cerium oxide slurry to stand for 24 hours after stirring is 2.5 to 15.0 mL/g.

2. The cerium oxide according to claim 1, wherein a ratio (A/B) of average particle size (A) to crystallite diameter (B) is 2.0 to 15.0.

3. A cerium oxide abrasive comprising the cerium oxide according to claim 1.

4. A cerium oxide ultraviolet absorber comprising the cerium oxide defined in claim 1.

5. A cerium oxide precious metal supported medium for catalyst comprising the cerium oxide defined in claim 1.

6. A method for producing cerium oxide from cerium(III) hydroxide, comprising:
a step of producing cerium(III) hydroxide by reacting cerium chloride and an alkaline substance at a solution temperature of 60° C. to 104° C. and a pH of 5 to 9; and
a step of producing cerium oxide by oxidizing the cerium (III) hydroxide with an oxidizing agent.

7. The method for producing cerium oxide according to claim 6, further comprising a step of cleaning the cerium(III) hydroxide.

8. The method for producing cerium oxide according to claim 6, further comprising a step of cleaning the cerium oxide.

9. A cerium oxide abrasive comprising the cerium oxide according to claim 2.

10. A cerium oxide ultraviolet absorber comprising the cerium oxide defined in claim 2.

11. A cerium oxide precious metal supported medium for catalyst comprising the cerium oxide defined in claim 2.

12. The method for producing cerium oxide according to claim 7, further comprising a step of cleaning the cerium oxide.
